(19) United States
(12) Patent Application Publication
(10) Pub. No.: US 2012/0079945 A1
(43) Pub. Date: Apr. 5, 2012

(54) Air Freshener Dispensing Register Cover

(75) Inventor: Randy W. Roberts, Harrison Township, MI (US)

(73) Assignee: Veronica J. Leggett, Macomb, MI (US)

(21) Appl. No.: 12/897,253

(22) Filed: Oct. 4, 2010

(51) Int. Cl. B01D 46/42; F24F 13/08; F24F 13/20

(52) U.S. Cl. 96/222; 454/284

(57) ABSTRACT

An air freshener dispensing register cover covers an air register and causes the airstream exiting from the air register to be filtered and to pass over a fragrance oil cartridge. The fragrance oil cartridge has diffusion paper saturated with fragrance oil. The components of the register cover are a base, a cartridge holder, a cutter and a top. The base has an opening and is sized to be positioned over an air register. The cartridge holder is attached to the base and holds a fragrance oil cartridge within the airstream exiting from the register. The cartridge holder and cutter cooperate to break a seal within the cartridge to release the fragrance oil within the cartridge. The top covers the base and has openings through which the airstream exits. The amount of fragrance oil remaining within the cartridge may be viewed through a transparent section of the register cover.

### BACKGROUND

Many homeowners and business owners desire to treat interior air with an air freshener. Such air treatment provides a pleasant scent to the atmosphere surrounding individuals. The air treatment may also mask underlying undesirable odors. An individual desiring to treat interior air with an air freshener typically uses an aerosol can of air freshener. The problem with this approach to air treatment is that it requires the individual to periodically retrieve and activate the aerosol can. Alternatively, the individual may use a stand-alone evaporative air freshener. While this approach avoids the necessity of periodic human intervention (i.e., the air is freshened automatically), it has other drawbacks. The air within which the device is used typically has very little flow. As a result, the evaporation of the air freshener is limited.

Most houses and businesses are equipped with heating, ventilating and air-conditioning systems. These systems treat air by heating it or cooling it. The system treated air is pressurized and forced through an air register. The airstream exiting from an air register has a much higher velocity compared to the air within the room wherein the register is positioned. This airstream exiting from an air register provides an opportunity for enhancing the dispersion of an air freshener from an evaporative air freshener cartridge. The air freshener will evaporate and disperse much more quickly when the cartridge is subjected to an airstream. What is needed is an air freshener dispensing register cover adapted to subject an evaporative air freshener cartridge to an airstream exiting from an air register. Ideally, this air freshener dispensing register cover will also be capable of filtering air exiting from an air register.

### SUMMARY

These needs are satisfied by the air freshener dispensing register cover described herein.

An air freshener dispensing register cover is intended to be used by positioning it over the opening of an air register. An air freshener dispensing register cover is comprised of a base, a fragrance oil cartridge holder, a fragrance oil cartridge diffusion paper cutter and a top.

The base is sized and shaped to cover an air register. The base has a central opening through which air exiting from an air register may pass. Optionally, the base has an air filter receptacle. The receptacle may be a slot positioned and configured to removably receive an air filter. The air filter receptacle is also positioned and configured such that a filter within the air filter receptacle will filter air exiting from the register when the base is attached to the register. Preferably, the base has one or more magnets attached to it for removably and magnetically attaching the air freshener dispensing register cover to a register.

The fragrance oil cartridge holder is attached directly or indirectly to the base. The phrase indirectly attached means that the holder is attached to another element and this other element is directly attached to the base. Although the described air freshener dispensing register cover is comprised of a plurality of components, it should be understood that some or all of these components may be molded as one integral piece. The fragrance oil cartridge holder is positioned on the base such that an air stream emanating from the register and entering one side of the base when the base is attached to the register impinges upon a surface of a fragrance oil cartridge within the holder and exits from the other side of the base.

The fragrance oil cartridge diffusion paper cutter is a bladelike structure which is positioned with respect to the base and the cartridge holder such that the exertion of pressure on a fragrance oil cartridge within the holder will cause the cutter to break a seal separating fragrance oil within the cartridge from cartridge diffusion paper. The breaking of the seal allows the fragrance oil or fragrance oil vapor to saturate the diffusion paper. In one embodiment, the fragrance oil cartridge holder is adapted to exert sufficient pressure upon a fragrance oil cartridge to cause a seal separating fragrance oil within the cartridge from cartridge diffusion paper to break when a fragrance oil cartridge is inserted into the fragrance oil cartridge holder. When the seal is broken, fragrance oil or fragrance oil vapor within the cartridge saturates the diffusion paper of the cartridge. In another embodiment, a cartridge cover is pivotally attached above the cartridge holder. The cartridge cover is adapted and configured to cause the seal of a fragrance oil cartridge within the fragrance oil cartridge holder to break from contact with the cutter when the cover is moved from an open position to a closed position.

The top is a structure which extends from the airstream exit side of the base. The top covers the central opening within the base. The top has a plurality of openings. The airstream coming from an air register attached to the air freshener dispensing register cover passes through the base and exits through the openings within the top. Preferably, the top has a transparent section which will allow the amount of fragrance oil within a fragrance oil cartridge inserted into the holder to be viewed.

Preferably, the base and the top are separated into a right side and a left side. These right side components and left side components are slidingly attached to each other such that the air freshener dispensing register cover is adapted to have an adjustable length.

### DRAWINGS

These and other features, aspects, and advantages of the present invention will become better understood with regard to the following description, appended claims, and accompanying drawings where:

FIG. 1 is a top perspective view of an air freshener dispensing register cover, which also shows an air register to which the air freshener dispensing register cover is about to be attached.

FIG. 2 is a bottom perspective view of the air freshener dispensing register cover of FIG. 1.

FIG. 3 is a sectional view of the fragrance oil cartridge holder of the air freshener dispensing register cover of FIG. 2 and FIG. 8.

FIG. 4 is a top perspective view of a second embodiment of an air freshener dispensing register cover.

FIG. 5 is a top perspective view of a third embodiment of an air freshener dispensing register cover, wherein a cartridge holder with a transparent cover is positioned near the right end of the air freshener dispensing register cover.

FIG. 6 is a top view of an air freshener dispensing register cover adapted to have an adjustable length.

FIG. 7 is a top view of a diffusion mask positioned over the diffusion paper surface of a fragrance oil cartridge.

FIG. 8 is a top view of the air freshener dispensing register cover of FIG. 2.

FIG. 9 is a perspective view of an air freshener dispensing register cover provided with an air filter receptacle.

FIG. 10 is a top view of the air freshener dispensing register cover of FIG. 6.

### DESCRIPTION

A preferred embodiment of an air freshener dispensing register cover 20 is comprised of a base 28, a fragrance oil cartridge holder 40, a fragrance oil cartridge diffusion paper cutter 48, a top 62, and a fragrance oil cartridge cover 66. An object of an air freshener dispensing register cover 20 is to mix an air freshener with a stream of air passing through an air register 22. The air freshener may be provided by fragrance oil within a fragrance oil cartridge 50, a scented air filter 38, or both. An air freshener dispensing register cover 20 may be attached to an air register 22 by magnets 30 within the base 28, or by fasteners, such as screws, passing through fastener openings 32 within the base 28 and corresponding mount holes 26 within an air register 22. The amount of fragrance oil remaining within a fragrance oil cartridge 50 may be viewed by looking through an optional transparent cartridge cover 66 which covers the fragrance oil cartridge 50.

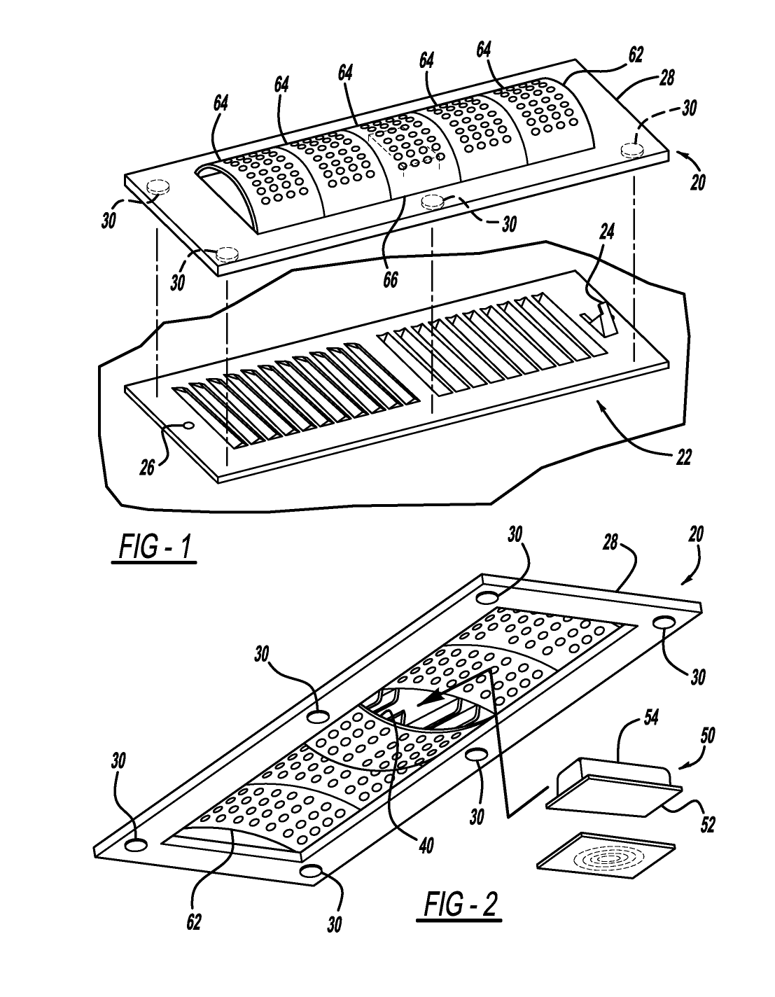

An air freshener dispensing register cover 20 is intended to be positioned over an air register 22. An air register 22 is shown in FIG. 1. Such air registers 22 are commonly used in houses and buildings. They provide an exit for the dispersion of air conditioned by a heating system or an air-conditioning system, or both. Air registers 22 can be mounted upon floors, walls and ceilings. They have a lever 24 which is used to control the amount of air dispersed. The lever 24 is adapted to reduce or enlarge the effective open area of the register 22 based upon the position of the lever 24. An air register 22 also typically has a pair of mounting holes 26 positioned on the perimeter of the air register 22, along its longitudinal axis, as shown in FIG. 1.

The base 28 may be formed from plastic by injection molding. The base 28 is sized and shaped to cover an air register, as shown in FIG. 1. Air registers 22 are available in various sizes and shapes. Thus bases 28 may have various sizes and shapes. The primary requirement is that the base 28 cover the air opening of the corresponding air register 22. The bottom side of the base 28, relative to its attachment to a floor mounted air register 22, should have a plurality of magnets 30 embedded within it. The magnets 30 allow the air freshener dispensing register cover 20 to be quickly and easily attached to and removed from a metallic air register 22. For example, an air freshener dispensing register cover 20 may be easily attached to a ceiling mounted air register 22 by placing the base 28 of the air freshener dispensing register cover 20 in contact with the air exit face of the air register 22. The base 28 should also have one or more fastener openings 32. Each of the fastener openings 32 are positioned to align with a corresponding mount hole opening 26, as previously described, within an air register 22. In this way, an air freshener dispensing register cover 20 may be secured to an air register 22 by a pair of fasteners, such as screws, or, in the alternative, the air freshener dispensing register cover 20 may be secured to the air register magnetically. Preferably, the base 28 is configured so that it does not interfere with the operation of the air register 22 control lever 24. This can be accomplished by forming a cut out within the base 28 in the area where the air register lever is located.

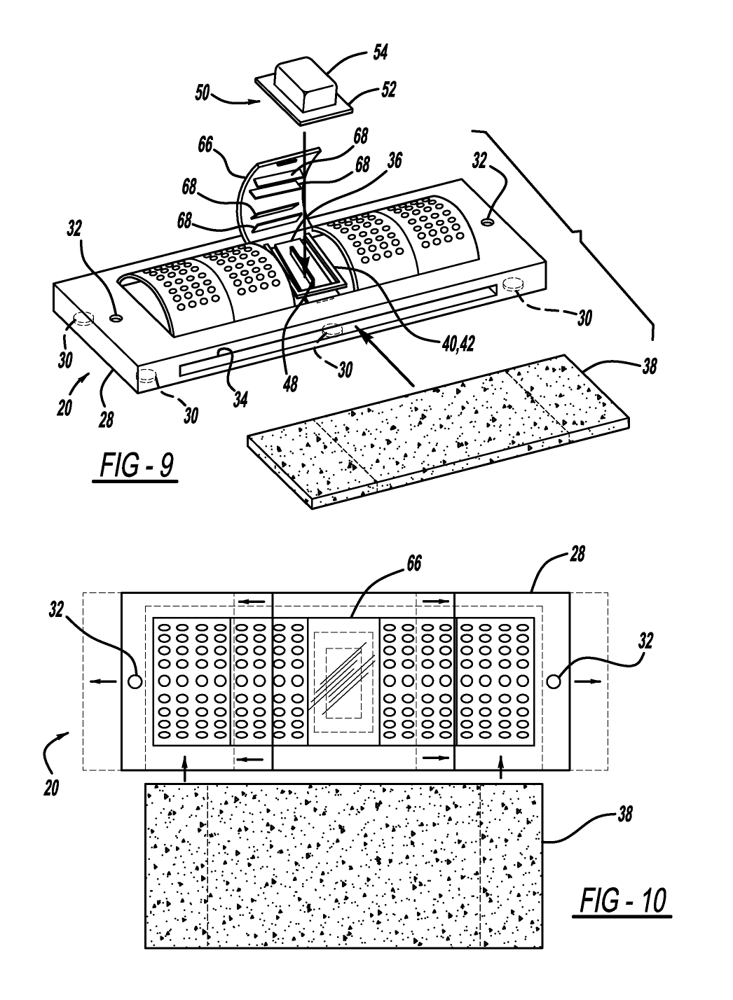

Preferably, the base 28 is adapted to receive an air filter 38. This can be accomplished by forming a slot like air filter receptacle 34 within the base 28, as shown in FIG. 9. The air filter receptacle 34 is positioned and configured to removably receive an air filter 38 such that the air filter 38 will filter air exiting from the register 22 when the base 28 is attached to the register 22. Because the air filter 38 is removable it may be easily removed and replaced. The airstream exiting from the air register 22 is filtered by the air filter 38. The air filter 38 may be scented with a common scenting agent. In this situation, scented air will exit from the air filter 38. An air freshener dispensing register cover 20 incorporating a scented air filter 38 may produce scented air only with a scented air filter 38. It may also produce scented air only with a fragrance oil cartridge 50. Or, it may produce scented air using both a scented air filter 38 and a fragrance oil cartridge 50. When a fragrance oil cartridge 50 is to be used the base 28 should also be equipped with a cutter support member 36. The fragrance oil cartridge 50 requires the use of a diffusion paper cutter 48. The diffusion paper cutter 48, should be attached to the cutter support 36. Otherwise, the diffusion paper cutter 48 must be attached to some other aspect of the air freshener dispensing register cover 20 structure.

The preferred embodiments of air freshener dispensing register covers 20 use fragrance oil cartridges 50 to treat the airstream exiting from a register 22 with an air freshener. The fragrance oil cartridge 50 contains fragrance oil. The fragrance oil is allowed to come into contact with a diffusion paper surface 52 of the fragrance oil cartridge 50 in order to facilitate dispersion of the fragrance oil into the airstream. However, it is desirable to separate fragrance oil from diffusion paper 52 when the fragrance oil cartridge 50 is being stored prior to use. The preferred fragrance oil cartridge 50 is comprised of diffusion paper 52, a capsule 54, a seal and fragrance oil. The capsule 54 is formed as a container with an open surface. The open surface is covered by diffusion paper 52 and a foil seal. The foil seal separates the fragrance oil within the capsule 54 from the diffusion paper 52. This prevents the fragrance oil from dispersing and evaporating prior to the fragrance oil cartridge 50 being used. The seal must be broken in order to use the fragrance oil cartridge to disperse the fragrance oil. The diffusion paper cutter 48 functions to break the seal between the fragrance oil and the diffusion paper. When the seal is broken, the fragrance oil comes into contact with the diffusion paper 52. The fragrance oil may be readily evaporated from the diffusion paper 52 by an airstream passing over the fragrance oil cartridge 50, after the seal has been broken. The capsule 54 should be transparent. This will allow a user to view the amount of fragrance oil remaining and to replace the fragrance oil cartridge 50 when necessary.

There may be times when it is desirable to restrict the amount of fragrance oil being evaporated from a fragrance oil cartridge 50 by an airstream passing through the air freshener dispensing register cover 20. For example, based upon user preference and room size a user may decide that too much fragrance oil is being evaporated. In such a situation a diffusion paper mask 60 may be placed over the diffusion paper 52 to reduce the amount of diffusion paper 52 exposed to an airstream. FIG. 2 and FIG. 7 show an adjustable mask 60 attached to the diffusion paper 52 of a fragrance oil cartridge 50. The mask 60 may be secured to the diffusion paper 52 with an adhesive. Other methods of securing the mask 62 to the diffusion paper 52 may also be used. The perimeter of the diffusion paper 52 may have parallel rails attached to it. The rails would be adapted to receive and secure the mask 60. The amount of fragrance oil evaporated from diffusion paper 52 covered with a mask 60 for a given airstream depends upon the surface area of an opening within the mask 60. The surface area of the opening within the mask 60 may be selectable. FIG. 7 shows a selectable surface area mask. Concentric pullout sections of the mask are shown with circular dotted lines. The perimeters of the sections are perforated. Thus, a user may select the desired opening by removing some of the mask 60 from its center to a selected perforated circular perimeter. In FIG. 7 the smallest center perforated section is about to be removed.

A fragrance oil cartridge holder 40 is adapted to hold a fragrance oil cartridge 50 such that the diffusion paper cutter 48 may break the seal separating the fragrance oil from the diffusion paper 52, and also such that fragrance oil may be evaporated from the diffusion paper 52 by an airstream passing through the air freshener dispensing register cover 20. The fragrance oil cartridge holder 40 is attached to the base 28. This attachment to the base 28 may be direct or indirect. In the indirect scenario, the fragrance oil cartridge holder 40 is attached to another part of the air freshener dispensing register cover 20 structure, but that other part is attached to the base 28. It should be understood that, although the air freshener dispensing register cover 20 is described as being comprised of a plurality of components attached to each other these components may be elements of one integral piece. For example, the base 28, the top 62 and the diffusion paper cutter 48 may be parts of one integrally molded piece.

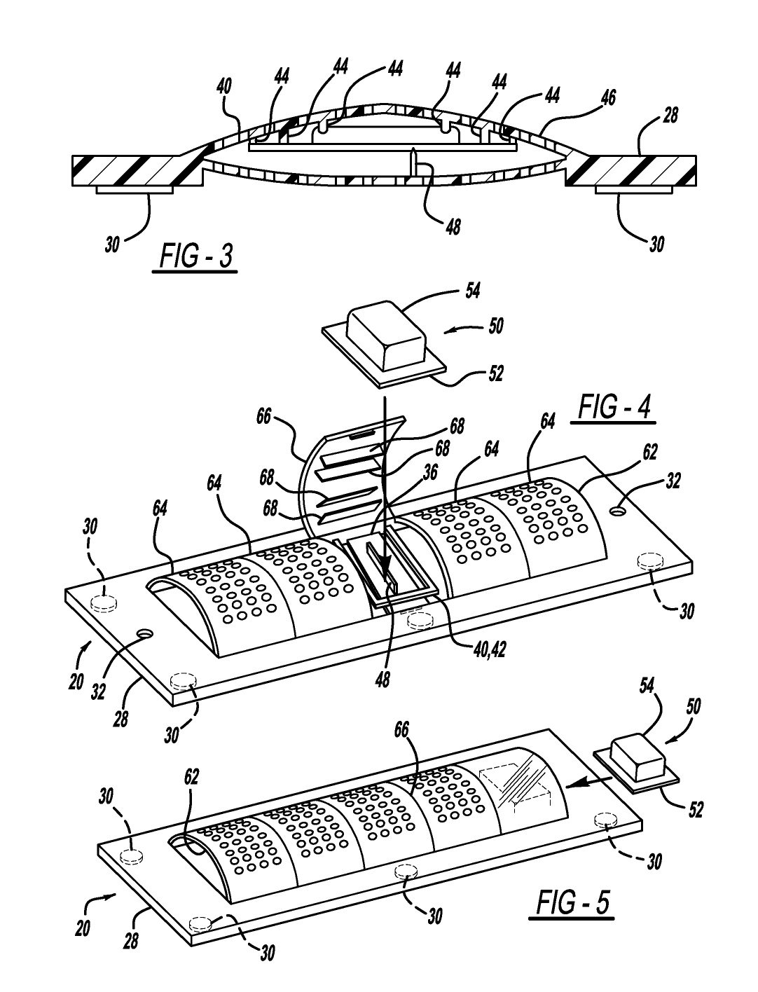

The fragrance oil cartridge holder 40 is positioned with respect to the base 28 and the holder 40 such that the exertion of pressure on a fragrance oil cartridge 50 within the holder causes a seal separating the fragrance oil within the cartridge 50 from cartridge diffusion paper 52 to break, allowing the fragrance oil to saturate the diffusion paper 52. One structure which implements these features of the fragrance oil cartridge holder 40 is shown in FIG. 2 and FIG. 3. There, the cartridge holder 40 consists of an oval shaped frame 46 formed within the base 28. The bottom surface of the frame 46 has a diffusion paper cutter 48 perpendicularly extending upward from it. This diffusion paper cutter 48 breaks the seal between the fragrance oil and the diffusion paper 52 when a fragrance oil cartridge 50 is inserted into the cartridge holder 40. Upper struts 44 project perpendicularly downward from the top surface of the frame 46. The struts 44 contact the fragrance oil cartridge 50 within the frame 46 and exert a downward pressure on the fragrance oil cartridge 50 which is opposed by the diffusion paper cutter 48. This pressure increases as the fragrance oil cartridge 50 enters and becomes seated within the cartridge holder 40. The frame 46 may also be equipped with guides which are parallel to the struts 44, but extend downwardly from the upper surface of the frame 46, below the bottom surface of the fragrance oil cartridge 50 in such a way that the guides restrain and confine the fragrance oil cartridge 50 in a selected position. Preferably, the frame 46 is provided with air openings on its upper surface and on its lower surface, as shown in FIG. 3. This will permit the airstream exiting the air register 22 to directly pass over the fragrance oil cartridge 50. In a related embodiment, the cartridge holder 40 and the fragrance oil cartridge 50 are positioned at one end of the base 28, as shown in FIG. 5. Note that the portion of the top 62 covering the fragrance oil cartridge 50 is transparent. This allows the amount of fragrance oil remaining within the fragrance oil cartridge 50 to be viewed.

Another structure which implements the described features of the fragrance oil cartridge holder is shown in FIG. 4 and FIG. 9. This is the preferred structure. The diffusion paper cutter 48 is attached to the cutter support 36 of the base 28. The diffusion paper cutter 48 is perpendicularly aligned with the longitudinal axis of the base 28. A positioning element 42 is directly or indirectly attached to the base 28. The positioning element 42 may be fabricated from a piece of flexible plastic. The positioning element 42 is adapted to hold the fragrance oil cartridge 50 over the diffusion paper cutter 48 such that downward closing pressure on the cartridge cover 66 causes the seal of the fragrance oil cartridge 50 to break. This implementation of the fragrance oil cartridge holder 40 is used with a cartridge cover 66. The cartridge cover 66 is pivotally connected to the base 28. Again, the connection may be direct or indirect. The pivotal connection permits the cartridge cover 66 to be positioned in an open position, as shown in FIG. 4 or a closed position, as shown in FIG. 1. Cartridge cover projections 68 extend downwardly from the bottom surface of the cartridge cover 66, as shown in FIG. 4 and FIG. 9. The cartridge cover projections 68 are configured such that they exert a downward force upon a fragrance oil cartridge 50 positioned within the cartridge holder 40 when the cartridge cover 66 is closed. The force is calibrated to cause the seal of the fragrance oil cartridge 50 to break, but to leave the diffusion paper 52 of the fragrance oil cartridge 50 intact. When the seal of the fragrance oil cartridge is broken, fragrance oil or fragrance oil vapor saturates the diffusion paper 52.

The top 62 extends from the airstream exit side of the base 28. The top 62 covers a large opening within the base 28, as shown in FIG. 4. This opening within the base 28 functions to allow air exiting from an attached air register 22 pass through the base 28 and the air freshener dispensing register cover 20. The top 62 and the base may be one integral piece. The top 62 is formed with a plurality of openings 64. The airstream from an air register 22 exits the air freshener dispenser register cover 20 through the top cover opening 64. The top cover 62 should also have lateral openings at the longitudinal ends of the top 62, as shown in FIG. 1 and FIG. 9. These are the semi lunar shaped openings at the interfaces of the longitudinal ends of the top 62 and the base 28. The airstream also exits from the air register 22 through these openings. The top 62 should be formed with a radiused exterior, as shown in FIG. 1 and FIG. 9. When the air freshener dispensing register cover 20 is attached to a floor mounted air register 22, the radiused exterior of the top 62 will minimize any injury hazard presented to a user walking over the air freshener dispensing register cover 20. Preferably, when a cartridge cover 66 is used, the cartridge cover should be centered within the top 62, as shown in FIG. 1 and FIG. 9. It should have openings to allow the airstream to exit, similar to the airstream exit openings on the adjacent top 62 structure. The cartridge cover 62 should also be transparent. This permits the amount of fragrance oil remaining within a fragrance oil cartridge 50 positioned within the cartridge holder 40 to be viewed.

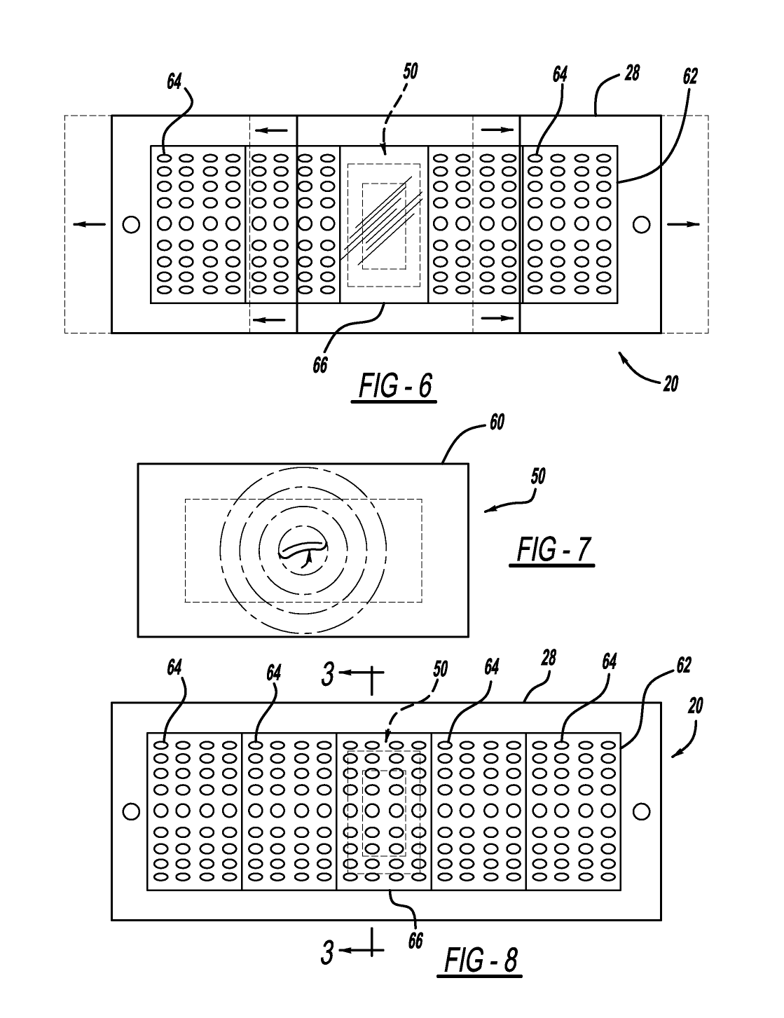

In the preferred embodiment, the air freshener dispensing register cover 20 is adapted to have an adjustable length. This is shown in FIG. 6 and FIG. 10. Air registers 22 are available with differing lengths. If the air freshener dispensing register cover 20 does not have an adjustable length, differing length air registers 22 will require different and separate air freshener dispensing register covers 22. However, if the length of an air freshener dispensing register cover 20 is adjustable, that air freshener dispensing register cover 20 will be universally usable on air registers 22 within the length range of that adjustable length air freshener dispensing register cover 20, so long as the register width 22 is not incompatible with the dimensions of the air freshener dispensing register cover 20. An adjustable length air freshener dispensing register cover 20 is adapted to have a right sided base 28 and top 62 and a left sided base 28 and top 62. The right side and the left side are slidingly interfaced so that they form a length adjustable structure.

The air filter 38 is sized and shaped to be insertable into the air filter receptacle 34. The air filter 38 may be scented or unscented. It may be scented with fragrance oil or another scenting agent. If the air filter 38 is scented it may be the sole source of imparting an air freshener to the airstream passing through the air freshener dispensing register cover 20. Alternatively, a scented air filter 38 may be used together with a fragrance oil cartridge 50. Similarly, a fragrance oil cartridge 50 may be used alone without any air freshener supplied by a filter 38. The air filter 38 may have tear off sections for use with a length adjustable air freshener dispensing register cover 20. Such tear off sections are shown in FIG. 9 and FIG. 10. The lateral peripheries of the air filters 38 shown are sectioned with perforations. The perforations facilitate the tearing off of portions of the filter 38 to reduce the filter 38 length. An air freshener dispensing register cover 20 may be used with or without an air filter 38. In other words, the air filter receptacle 34 of the base 28 and the air filter 38 are optional elements of an air freshener dispensing register cover 20.

In order to use an air freshener dispensing register cover 20, one is first selected. If the base 28 has an air filter receptacle 34, optionally an air filter 38 is inserted into the air filter receptacle 34. A fragrance oil cartridge 50 is inserted into the cartridge holder 40. The seal of the fragrance oil cartridge 40 is broken by inserting the fragrance oil cartridge 50 into the fragrance oil cartridge holder 40, or by closing the cartridge cover 66 onto the fragrance oil cartridge 50, depending upon the air freshener dispensing register cover 20 embodiment selected. The air freshener dispensing register cover 20 is then attached to an air register 22. The air freshener dispensing register cover 20 may be magnetically attached to the register 22, or it may be secured to the register 22 with fasteners. This process is reversed to remove the air freshener dispensing register cover 20 from the register 22. While the air freshener dispensing register cover 20 is in use, the amount of remaining fragrance oil may be viewed by looking at the capsule 54 of the fragrance oil cartridge 50. The air filter 38 and the fragrance oil cartridge 50 may be removed and replaced as desired.

Although the invention has been shown and described with reference to certain preferred embodiments and methods, those skilled in the art undoubtedly will find alternative embodiments and methods obvious after reading this disclosure. With this in mind, the following claims are intended to define the scope of protection to be afforded the inventor, and those claims shall be deemed to include equivalent constructions insofar as they do not depart from the spirit and scope of the present invention.

What is claimed is:

1. An air freshener dispensing register cover comprising:
(a) a base sized and shaped to cover an air register;
(b) a fragrance oil cartridge holder attached to the base, said fragrance oil cartridge holder being positioned on the base such that an airstream emanating from the register and entering one side of the base when the base is attached to the register impinges upon a surface of a fragrance oil cartridge within the holder and exits from the other side of the base; and
(c) a top extending from the airstream exit side of the base, said top having a plurality of openings for an airstream to exit.

2. An air freshener dispensing register cover comprising:
(a) a base sized and shaped to cover an air register, said base having an air filter receptacle positioned and configured to removably receive an air filter such that the filter will filter air exiting from the register when the base is attached to the register;
(b) a fragrance oil cartridge holder attached to the base, said fragrance oil cartridge holder being positioned on the base such that an airstream emanating from the register and entering one side of the base when the base is attached to the register impinges upon a surface of a fragrance oil cartridge within the holder and exits from the other side of the base;
(c) a fragrance oil cartridge diffusion paper cutter positioned with respect to the base and the holder such that the exertion of pressure on a cartridge within the holder causes a seal separating fragrance oil within the cartridge from cartridge diffusion paper to break, allowing the fragrance oil to saturate the diffusion paper; and
(d) a top extending from the airstream exit side of the base, said top having a plurality of openings for an airstream to exit.

3. The air freshener dispensing register cover of claim 2, wherein the fragrance oil cartridge holder is adapted to exert sufficient pressure upon a fragrance oil cartridge to cause a seal separating fragrance oil within the cartridge from cartridge diffusion paper to break, allowing the fragrance oil to saturate the diffusion paper when a fragrance oil cartridge is inserted into the fragrance oil cartridge holder.

4. The air freshener dispensing register cover of claim 2, wherein the top has a transparent section which allows the amount of fragrance oil within a fragrance oil cartridge inserted into the holder to be viewed.

5. The air freshener dispensing register cover of claim 2, wherein said base has one or more magnets for removably attaching said base to a register.

6. The air freshener dispensing register cover of claim 2, wherein the air freshener dispensing register cover is adapted to have an adjustable length.

7. An air freshener dispensing register cover comprising:
(a) a base sized and shaped to cover an air register, said base having one or more magnets for removably attaching said base to a register, said base having one or more openings each for receiving a fastener, each of said one or more openings being positioned to align with an opening within a register to secure the base to a register with a fastener, said base having an air filter receptacle positioned and configured to removably receive an air filter such that the filter will filter air exiting from the register when the base is attached to the register;
(b) a fragrance oil cartridge holder attached to the base, said fragrance oil cartridge holder being positioned on the base such that an airstream emanating from the register and entering one side of the base when the base is attached to the register impinges upon a surface of a fragrance oil cartridge within the holder and exits from the other side of the base;
(c) a fragrance oil cartridge diffusion paper cutter positioned with respect to the base and the holder such that the exertion of pressure on a cartridge within the holder causes a seal separating fragrance oil within the cartridge from cartridge diffusion paper to break, allowing the fragrance oil to saturate the diffusion paper;
(d) a top extending from the airstream exit side of the base, said top having a plurality of openings for an airstream to exit; and
(e) a fragrance oil cartridge cover pivotally connected to the base, said cartridge cover being adapted to exert sufficient force upon a fragrance oil cartridge within the fragrance oil cartridge holder to cause the cutter to break the seal of a fragrance oil cartridge positioned within the fragrance oil cartridge holder, said fragrance oil cartridge cover having sufficient transparency to permit the amount of fragrance oil remaining within the fragrance oil cartridge to be viewed.

8. The air freshener dispensing register cover of claim 7, further comprising a fragrance oil cartridge positioned within the fragrance oil cartridge holder and an air filter positioned within the filter receptacle.

9. The air freshener dispensing register cover of claim 7, wherein the air freshener dispensing register cover is adapted to have an adjustable length.

10. The air freshener dispensing register cover of claim 8, further comprising a diffusion mask positioned over diffusion paper of the fragrance oil cartridge, said the diffusion mask having an aperture of less area than the area of the diffusion paper, for limiting evaporation of fragrance oil from the diffusion paper.
